(19) United States
(12) Patent Application Publication
(10) Pub. No.: US 2026/0170680 A1
(43) Pub. Date: Jun. 18, 2026

(54) RECOGNITION PROCESSING APPARATUS, RECOGNITION PROCESSING METHOD, AND STORAGE MEDIUM FOR STORING PROGRAM

(71) Applicant: JVCKENWOOD Corporation, Yokohama-shi (JP)

(72) Inventor: Takuya OGURA, Yokohama-shi (JP)

(21) Appl. No.: 19/531,735

(22) Filed: Feb. 6, 2026

Related U.S. Application Data
(63) Continuation of application No. PCT/JP2024/018157, filed on May 16, 2024.

(30) Foreign Application Priority Data
Sep. 22, 2023 (JP) 2023-158143

(51) Int. Cl. G06T 7/73; G06T 7/13; G06T 7/246; G06V 10/70; G06V 20/40; G06V 20/58; G06V 40/10

(52) U.S. Cl. CPC G06T 7/73; G06T 7/13; G06T 7/246; G06T 2207/10016; G06T 2207/30196; G06T 2207/30252; G06V 10/70; G06V 20/40; G06V 20/58; G06V 40/10

(57) ABSTRACT

A recognition processing apparatus includes: a video acquisition unit that acquires a filmed video; an object detection unit that detects an object included in the filmed video by using a detection model trained on an image of the object by machine learning; a lower end estimation unit that estimates, when the object included in a range that overlaps a lower edge of the filmed video is detected by the object detection unit, a lower end position of the object potentially located below the lower edge of the filmed video; and a distance calculation unit that calculates distance information on the object by using the lower end position estimated by the lower end estimation unit.

### CROSS REFERENCE TO RELATED APPLICATION

This application is a continuation of application No. PCT/JP2024/018157, filed on May 16, 2024, and claims the benefit of priority from the prior Japanese Patent Application No. 2023-158143, filed on Sep. 22, 2023, the entire content of which is incorporated herein by reference.

### BACKGROUND

### 1. Technical Field

The present disclosure relates to a recognition processing apparatus, a recognition processing method, and a storage medium for storing a program.

### 2. Description of the Related Art

A technology for detecting an object such as a pedestrian from an image capturing a scene around a vehicle by using an image recognition process such as pattern matching is known (see, for example, Patent literature 1).

[Patent literature 1] JP2022-139374

When an object is located near the outer edge of a video filmed by a camera, the object may not be properly detected because the entirety of the object is not included in the video.

### SUMMARY

A recognition processing apparatus according to an embodiment of the present disclosure includes: a video acquisition unit that acquires a filmed video; an object detection unit that detects an object included in the filmed video by using a detection model trained on an image of the object by machine learning; a lower end estimation unit that estimates, when the object included in a range that overlaps a lower edge of the filmed video is detected by the object detection unit, a lower end position of the object potentially located below the lower edge of the filmed video; and a distance calculation unit that calculates distance information on the object by using the lower end position estimated by the lower end estimation unit.

Another embodiment of the present disclosure relates to a recognition processing method including, for execution by a recognition processing apparatus: acquiring a filmed video; detecting an object included in the filmed video by using a detection model trained on an image of the object by machine learning; estimating, when the object included in a range that overlaps a lower edge of the filmed video is detected, a lower end position of the object potentially located below the lower edge of the filmed video; and calculating distance information on the object by using the lower end position estimated.

Still another embodiment of the present disclosure relates to a non-transitory recording medium storing a program including processor-executed modules including: a module that acquires a filmed video; a module that detects an object included in the filmed video by using a detection model trained on an image of the object by machine learning; a module that estimates, when the object included in a range that overlaps a lower edge of the filmed video is detected, a lower end position of the object potentially located below the lower edge of the filmed video; and a module that calculates distance information on the object by using the lower end position estimated.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram schematically showing a functional configuration of a recognition processing apparatus according to the first embodiment;

FIG. 2 schematically shows an example of a filmed video that includes an object;

FIG. 3 schematically shows exemplary detection areas set in the filmed video;

FIGS. 4A-4E schematically show exemplary input images used in machine learning of the detection model;

FIG. 5 is a flowchart showing an exemplary flow of the recognition processing method according to the first embodiment;

FIG. 6 is a flowchart showing an exemplary flow of the process of step S16 of FIG. 5;

FIG. 7 is a block diagram schematically showing a functional configuration of a recognition processing apparatus according to the second embodiment;

FIGS. 8A-8C schematically show an example of the object tracked over multiple frames that make up the filmed video;

FIG. 9 is a flowchart showing an exemplary flow of the recognition processing method according to the second embodiment;

FIG. 10 is a block diagram schematically showing a functional configuration of a recognition processing apparatus according to the third embodiment;

FIGS. 11A, 11B schematically show an exemplary method of detecting an object located at the lower edge of the filmed video; and

FIG. 12 is a flowchart showing an exemplary flow of the recognition processing method according to the third embodiment.

### DETAILED DESCRIPTION

The invention will now be described by reference to the preferred embodiments. This does not intend to limit the scope of the present invention, but to exemplify the invention.

A description will be given below of embodiments of the present disclosure with reference to the drawings. Specific numerical values shown in the embodiments are by way of example only to facilitate the understanding of the invention and should not be construed as limiting the disclosure unless specifically indicated as such. Those elements in the drawings not directly relevant to the present disclosure are omitted from the illustration.

### First Embodiment

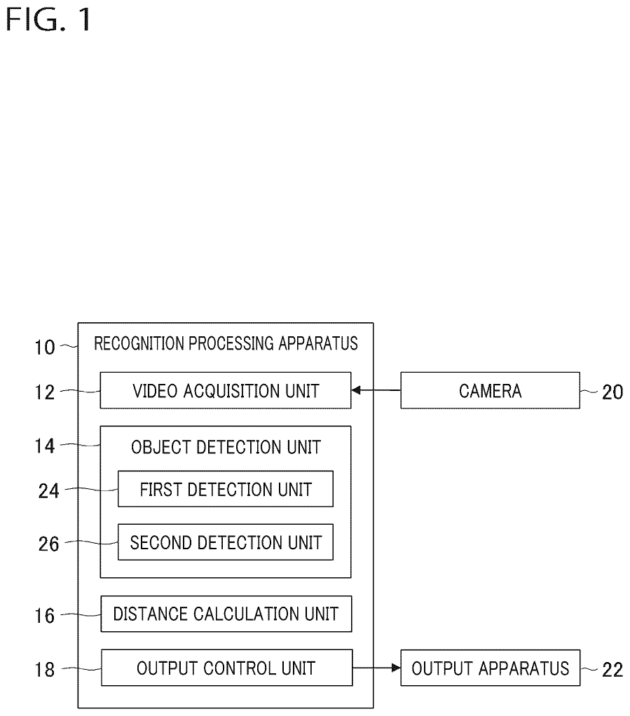

FIG. 1 is a block diagram schematically showing a functional configuration of a recognition processing apparatus 10 according to the first embodiment. The recognition processing apparatus 10 includes a video acquisition unit 12 and an object detection unit 14. The recognition processing apparatus 10 can be additionally equipped with a distance calculation unit 16 and an output control unit 18. The recognition processing apparatus 10 acquires, for example, a filmed video that could include an object such as a pedestrian around and detects the object included in the filmed video.

In the embodiment, a case in which the recognition processing apparatus 10 is installed on a smart pole is presented as an example. A smart pole is installed, for example, on a street and is equipped with an antenna and communication equipment to provide wireless communication capabilities, lighting equipment to illuminate the street, and a camera to film vehicles and pedestrians passing on the road. The recognition processing apparatus 10 is fixed at a predetermined place. The recognition processing apparatus 10 may be mounted on a movable body or on a flying body such as a vehicle or a drone.

The term “object”, detected by the recognition processing apparatus 10, is applicable to an optional body. In the embodiment of the present disclosure, the object is described as a being a person such as pedestrian by way of example.

The functional blocks presented in this embodiment are implemented by coordination of hardware and software. The hardware of the recognition processing apparatus 10 is implemented by devices and mechanical apparatus exemplified by a processor such as a CPU (Central Processing Unit) and a GPU (Graphics Processing Unit) of a computer and by a memory such as a ROM (Read Only Memory) and a RAM (Random Access Memory) of a computer. The software of the recognition processing apparatus 10 is implemented by a computer program, etc.

The video acquisition unit 12 acquires a video filmed by a camera 20 (also called the filmed video). The camera 20 is installed on the smart pole and films a video around the smart pole. The camera 20 is, for example, installed in the upper part of the smart pole and films a video having an angle of view that looks down on the ground where the smart pole is installed. The camera 20 captures visible light to produce a color video or a monochrome video. The camera 20 may be an infrared camera and may capture infrared rays to generate a thermal image. The video filmed by the camera 20 comprises, for example, moving images of, for example, 30 frames per second or 60 frames per second.

The object detection unit 14 detects an object from the video acquired by the video acquisition unit 12. In other words, the object detection unit 14 detects an area in the video acquired by the video acquisition unit 12 that includes the object (hereinafter referred to as a detection area). The object detection unit 14 scans, in each frame of the video acquired by the video acquisition unit 12, a detection window with reference to a single or multiple detection models for detecting an object and calculates a recognition score indicating the possibility that the object is included in each detection window. The recognition score is calculated in, for example, a range of 0.0-1.0. The higher the possibility of the object being included in the video in the detection window, the larger the recognition score (i.e., the value is closer to 1.0), and the lower the possibility of the object being included, the smaller the recognition score (i.e., the value closer to 0.0). The object detection unit 14 detects the object by determining that the object is included in the detection window when the recognition score is equal to or higher than a predetermined threshold value such as 0.8.

The object detection unit 14 is equipped with a first detection unit 24 and a second detection unit 26.

The first detection unit 24 detects an object by using a first detection model trained on an entire image of a person (object) by machine learning. An entire image of a person is an image that includes the whole body of a person. The first detection unit 24 detects an object included in a range inside the filmed video, such as the neighborhood of the center of the filmed video, that does not overlap the outer edge. The first detection unit 24 detects, for example, an object for which the entirety of the object is included in the filmed video.

The second detection unit 26 detects an object by using a second detection model trained on a partial image of a person (object) by machine learning. A partial image of a person is an image that includes about half of the person's whole body. The second detection unit 26 detects an object included in a range that includes an area inside the outer edge of the filmed video (e.g., the neighborhood of the outer circumference of the filmed video) and that overlaps the outer edge. The second detection unit 26 detects an object for which a part of the object is included in the filmed video and for which the remaining part of the object is outside the angle of view and is not included in the filmed video.

Thus, the object detection unit 14 uses the first detection unit 24 to detect an object included in a range that does not overlap the outer edge of the filmed video by using the first detection model trained on the entire image of the object by machine learning and uses the second detection unit 26 to detect an object included in a range that includes an area inside the outer edge of the filmed video and that overlaps the outer edge by using the second detection model trained on the partial image of the object by machine learning.

The model used for machine learning can include an input corresponding to the image size (number of pixels) of an input image, an output that outputs a recognition score, and an intermediate layer that connects the input and the output. The intermediate layer can include a convolutional layer, a pooling layer, a fully connected layer, etc. The intermediate layer may have a multilayer structure and may be configured to enable deep learning. The model used for machine learning may be built by using a convolutional neural network (CNN). The model used for machine learning is not limited to the one described above, and a desired machine learning model may be used.

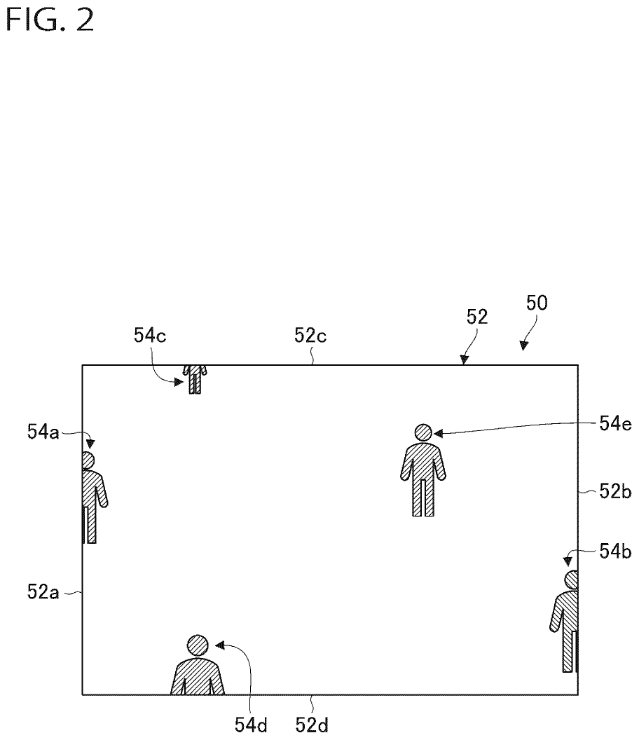

FIG. 2 schematically shows an example of a filmed video 50 that includes an object 54 (54a-54e). An outer edge 52 of the filmed video 50 corresponds to the angle of view of the camera 20. The outer edge 52 has a left edge 52a, a right edge 52b, an upper edge 52c, and a lower edge 52d. In this specification, the vertical and horizontal directions are set with reference to the angle of view of the camera 20 and mean the upper side, lower side, left side, and right side of the perspective of the camera 20.

The filmed video 50 includes an object 54e, which does not overlap the outer edge 52 and is located away from the outer edge 52, and objects 54a, 54b, 54c, and 54d located in ranges that overlap the outer edge 52. The entire image of the object 54e is included in the filmed video 50, and so the object is included in a range that does not overlap the outer edge. Meanwhile, the objects 54a-54d are included in part in the filmed video 50, and the remaining part is outside the angle of view and is not included in the filmed video 50. In other words, the objects 54a-54d are included in ranges that overlap the outer edge.

In the filmed video 50, the left part of the object 54a is outside the angle of view and is not included in the filmed video 50, and the right part is included in the filmed video 50. The right part of the object 54b is outside the angle of view and is not included in the filmed video 50, and the left part is included in the filmed video 50. The upper part of the object 54c is outside the angle of view and is not included in the filmed video 50, and the lower part is included in the filmed video 50. The lower part of the object 54d is outside the angle of view and is not included in the filmed video 50, and the upper part is included in the filmed video 50.

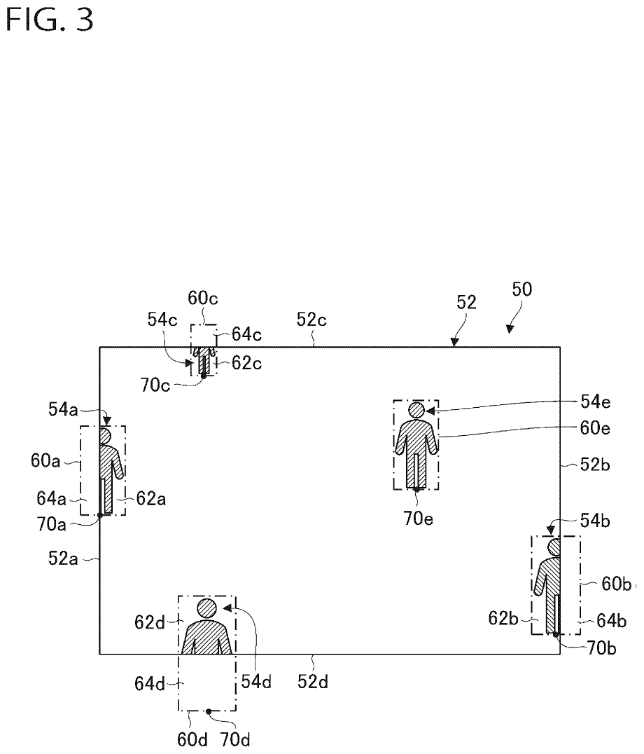

FIG. 3 schematically shows exemplary detection areas 60a-60e set when the object 54 is detected in the filmed video 50. In FIG. 3, the detection areas 60a-60e are indicated by rectangular frames of chain lines. The shape of the detection areas 60a-60e (e.g., aspect ratio) corresponds to the input size of the detection model used by the object detection unit 14. For example, the aspect ratio is about 2:1.

The first detection unit 24 uses the first detection model in the detection window for scanning inside the outer edge 52 of the filmed video 50 and detects an object included in the filmed video (e.g., the object 54e). The first detection unit 24 detects an object included in a range that includes an area inside the outer edge 52 of the filmed video 50 and that does not include an area outside the outer edge 52. When scanning the entirety of the filmed video 50 while changing the position and size of the detection window, for example, the first detection unit 24 detects an object by using the first detection model in the detection window for scanning an area inside the outer edge 52 of the filmed video 50.

The second detection unit 26 detects an object included in the filmed video (e.g., the objects 54a-54d) by using the second detection model in the detection window for scanning a range that overlaps the outer edge 52 of the filmed video 50. The second detection unit 26 detects an object included in a range that includes areas inside and outside the outer edge 52 of the filmed video 50. When scanning the entirety of the filmed video 50 while changing the position and size of the detection window, for example, the second detection unit 26 detects an object by using the second detection model in the detection window for scanning a range that includes the outer edge 52 of the filmed video 50.

The second detection unit 26 detects an object by using the second detection model in a range that overlaps at least one of the left edge 52a, right edge 52b, upper edge 52c, and lower edge 52d of the filmed video 50. For example, the detection area 60a set when the object 54a is detected includes an inner area 62a adjacent to the left edge 52a on the right side and an outer area 64a adjacent to the left edge 52a on the left side. For example, the detection area 60b set when the object 54b is detected includes an inner area 62b adjacent to the right edge 52b on the left side and an outer area 64b adjacent to the right edge 52b on the right side. For example, the detection area 60c set when the object 54c is detected includes an inner area 62c adjacent to the upper edge 52c on the lower side and an outer area 64c adjacent to the upper edge 52c on the upper side. For example, the detection area 60d set when the object 54d is detected includes an inner area 62d adjacent to the lower edge 52d on the upper side and an outer area 64d adjacent to the lower edge 52d on the lower side.

The second detection unit 26 can use multiple detection models to detect objects located at positions that overlap the left edge 52a, right edge 52b, upper edge 52c, and lower edge 52d of the filmed video 50, respectively. The second detection unit 26 may use, for example, at least one of a left edge detection model, right edge detection model, upper edge detection model, and lower edge detection model as the second detection model.

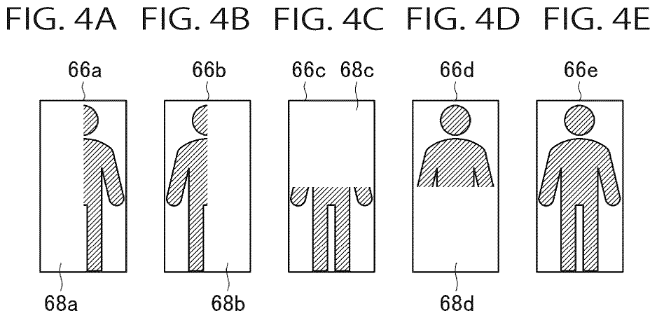

FIGS. 4A-4E schematically show exemplary input images used in machine learning of the detection model that detects a person by way of example. FIG. 4A shows a right partial image 66a of the object, which is used for machine learning of the left edge detection model. The right partial image 66a is an image that includes the right part of the object but does not include the left part. FIG. 4B shows a left partial image 66b of the object, which is used for machine learning of the right edge detection model. The left partial image 66b is an image that includes the left part of the object but does not include the right part. FIG. 4C shows a lower partial image 66c of the object, which is used for machine learning of the upper edge detection model. The lower partial image 66c is an image that includes the lower part of the object but does not include the upper part. FIG. 4D shows an upper partial image 66d of the object, which is used for machine learning of the lower edge detection model. The upper partial image 66d is an image that includes the upper part of the object but does not include the lower part. FIG. 4E shows an entire image 66e of the object, which is used for machine learning of the first detection model. The entire image 66e includes the entire image of the object.

The partial images 66a-66d shown in FIG. 4A-4D include margin parts 68a-68d that do not include the object. The margin parts 68a-68d are set so that the image size (e.g., aspect ratio) of the partial images 66a-66d match the image size (e.g., aspect ratio) of the entire image 66e. The brightness value of the margin parts 68a-68d is set to be different from the brightness value of the object and is set, for example, to be equivalent to the brightness value of the background of the object. By setting the margin parts 68a-68d, the recognition accuracy in the second detection area, which is set to include an area outside the outer edge 52 of the filmed video 50, can be improved.

The second detection unit 26 may detect a left edge object 56a and a right edge object 56b by using one, instead of both, of the left edge detection model and the right edge detection model. The second detection unit 26 may, for example, use the left edge detection model to detect the right edge object 56b. The second detection unit 26 can detect the right edge object 56b by flipping the image cut out in the right edge detection area 60b horizontally and then inputting the flipped image to the left edge detection model. The second detection unit 26 may conversely use the right edge detection model to detect the left edge object 56a. The second detection unit 26 can detect the left edge object 56a by flipping the image cut out in the left edge detection area 60a horizontally and then inputting the flipped image to the right edge detection model.

Referring back to FIG. 1, the distance calculation unit 16 calculates distance information on the object detected by the object detection unit 14. The distance calculation unit 16 calculates the distance to the object by, for example, using the lower end position of the object included in the filmed video 50. The lower end position of the object corresponds to the grounding position of the object and corresponds to the lower end positions 70a-70e (see FIG. 3) of the detection areas 60a-60e in which the object is detected. The distance calculation unit 16 may calculate the orientation of the object by using the lower end position of the object included in the filmed video 50. The distance calculation unit 16 may calculate, as the distance information on the object, the distance and the orientation from the camera 20. The distance calculation unit 16 may, for example, calculate position coordinates of the object by using a coordinate system with reference to the position of the smart pole on which the camera 20 is installed.

The distance calculation unit 16 can, for example, calculate the distance to the object by using the correlation between the distance from the camera 20 to the object and the lower end position of the object in the filmed video 50. The correlation between the distance and the lower end position may, for example, be calculated based on the angle of view of the camera 20 or may be actually measured around the smart pole on which the recognition processing apparatus 10 is installed. The distance calculation unit 16 can calculate the distance by using a table or a formula that shows the correlation between the distance and the lower end position.

When the object 54 included in a position that overlaps the lower edge 52d of the filmed video 50 is detected, the distance calculation unit 16 calculates the distance to the object 54 by using the lower end position of the detection area in which the object 54 is detected by using the second detection model. When the object 54d is detected by using the second detection model, for example, the distance calculation unit 16 calculates the distance to the object 54d by using the lower end position 70d of the detection area 60d in which the object 54 is detected. The lower end position 70d of the detection area 60d is located below the lower edge 52d of the filmed video 50 and so is outside the range of the filmed video 50 in the vertical direction, i.e., outside the angle of view of the camera 20. By using the lower end position located outside the range of the filmed video 50, the distance to the object included in a range overlaps the lower edge 52d of the filmed video 50 such as the object 54d can be calculated more properly. The lower end positions 70a, 70b, 70c, and 70e of objects not included in a position that overlaps the lower edge 52d, i.e., the objects 54a, 54b, 54c, and 54e, are within the range of the filmed video 50 in the vertical direction, i.e., within the range of the angle of view of the camera 20.

The output control unit 18 causes an output apparatus 22 to output object information on the object detected by the object detection unit 14. The object information may, for example, include information on whether the object is detected by the object detection unit 14, the number of objects detected by the object detection unit 14, and the position and distance of the detected object. The output apparatus 22 may be a communication apparatus or a wireless communication apparatus that outputs object information such as position and distance of the object by road-to-vehicle communication or vehicle-to-vehicle communication.

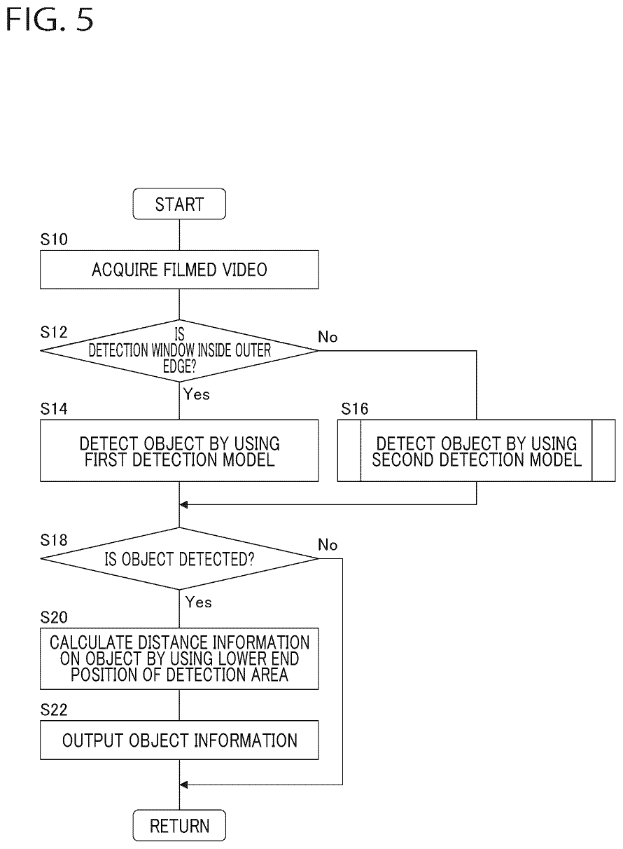

FIG. 5 is a flowchart showing an exemplary flow of the recognition processing method according to the first embodiment. The video acquisition unit 12 acquires the filmed video filmed by the camera 20 (step S10). The object detection unit 14 starts scanning the filmed video by using a detection window and determines whether the detection window is inside the outer edge of the filmed video, i.e., whether the detection window is located in a range that includes an area inside the outer edge of the filmed video and that does not overlap the outer edge (step S12). The assumption in the recognition process of the embodiment is that the detection window is scanned over a range beyond the outer edge of the filmed video.

The object detection unit 14 detects the object by using the first detection model in the detection window, when it is determined that the detection window is located inside the outer edge of the filmed video (Yes in step S12) (step S14). The object detection unit 14 detects the object by using the second detection model (step S16), when the detection window is not located inside the outer edge of the filmed video, i.e., the detection window is located in a range that overlaps the outer edge of the filmed video (No in step S12).

The object detection unit 14 then determines whether the object is detected (step S18). The object detection unit 14 determines in step S14 that the object is detected when the recognition score based on the first detection model is equal to or higher than a predetermined threshold value. Further, the object detection unit 14 determines in step S16 that the object is detected when the recognition score calculated by using the second detection model is equal to or higher than a predetermined threshold value.

When the object is detected by the object detection unit 14 (Yes in step S18), the distance calculation unit 16 calculates the distance information on the object by using the lower end position of the detection area in which the object is detected (step S20). The output control unit 18 outputs the object information on the detected object (step S22). When the object is not detected by the object detection unit 14 (No in step S18), the processes of steps S20 and S22 can be skipped.

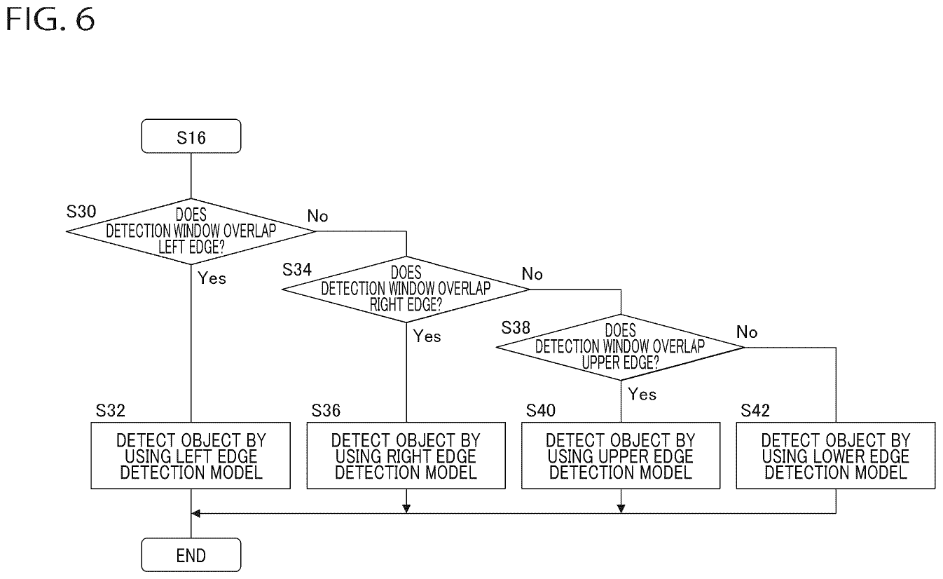

FIG. 6 is a flowchart showing an exemplary flow of the process of step S16 of FIG. 5. FIG. 6 shows an example of using the second detection model used by the second detection unit 26 to detect the object according to the position of the detection window. As described above, the second detection unit 26 uses the left end detection model, the right edge detection model, the upper edge detection model, and the lower edge detection model as the exemplary second detection model. The object detection unit 14 detects the object by using the left edge detection model (step S32) when it is determined that the detection window is located at a position that overlaps the left edge of the filmed video (Yes in step S30). The object detection unit 14 detects the object by using the right edge detection model (step S36) when the object detection unit 14 determines that the detection area is not located at a position that overlaps the left edge of the filmed video (No in step S30) and determines that the detection area is located at a position that overlaps the right edge of the filmed video (Yes in step S34). The object detection unit 14 detects the object by using the upper edge detection model when the object detection unit 14 determines that the detection area is not located at a position that overlaps either the left or the right edge of the filmed video (No in step S34) and determines the detection area is located at a position that overlaps the upper edge of the filmed video (Yes in step S38). The object detection unit 14 detects the object by using the lower edge detection model when the object detection unit 14 determines that the detection area is not located at a position that overlaps either the left edge, right edge, or upper edge of the filmed video (step S38 No).

According to the embodiment, it is possible to improve the accuracy of detection of an object, for which the entire image is not included in the filmed video because of the object's position that overlaps the outer edge of the filmed video, by using the second detection model. For example, an object moving in a direction approaching the camera 20 moves from an area above the lower edge of the filmed video to an area below so that it grows difficult to film the entire image of the object as the object approaches the camera 20. Lowering the angle of view of the camera 20 makes it possible to film the entire image of the object located near the camera 20 but makes it impossible to film the object located distanced from the camera 20. According to the embodiment, the accuracy of detection of the object located at the outer edge of the filmed video is improved so that the range in which the object can be detected by using a single camera 20 can be expanded.

According to the embodiment, the lower end position of the object can be identified even if the lower end position of the object is not included in the angle of view of the filmed video because of the object's position that overlaps the lower edge of the filmed video. As a result, the distance to the object located near the camera 20 can be calculated more properly.

### Second Embodiment

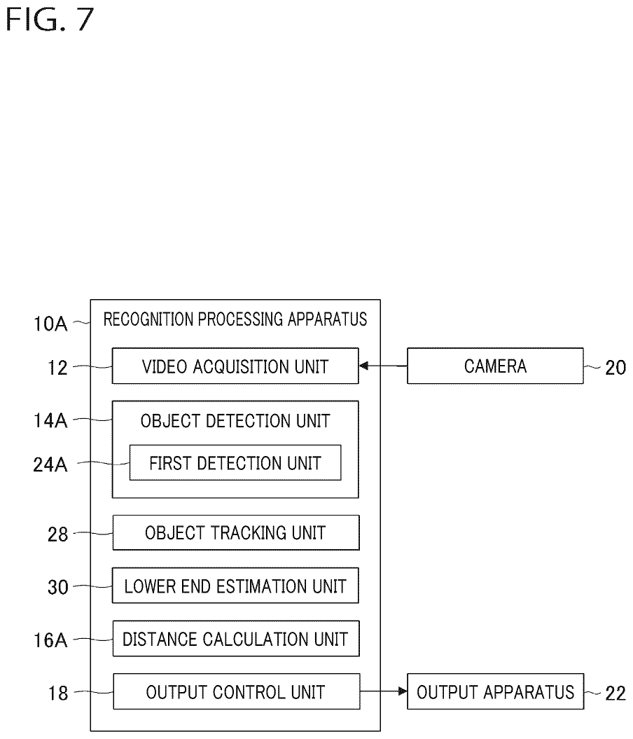

FIG. 7 is a block diagram schematically showing a functional configuration of a recognition processing apparatus 10A according to the second embodiment. The recognition processing apparatus 10A according to the second embodiment differs from the recognition processing apparatus 10 according to the first embodiment in that an object tracking unit 28 and a lower end estimation unit 30 are additionally provided. The following description of the second embodiment highlights the difference from the first embodiment. A description of common features is omitted as appropriate.

The recognition processing apparatus 10A is equipped with a video acquisition unit 12, an object detection unit 14A, an object tracking unit 28, a lower end estimation unit 30, a distance calculation unit 16A, and an output control unit 18. The video acquisition unit 12 and the output control unit 18 may be configured in a manner similar to the first embodiment. The object detection unit 14A differs from the first embodiment in that the first detection unit 24A is provided but the second detection unit 26 is not provided.

The first detection unit 24A detects an object by using the first detection model trained on the entire image of the object by machine learning. The first detection unit 24A detects an object included in the filmed video by using the first detection model. The first detection unit 24A detects an object located near the center of the filmed video by using the first detection model and also detects an object located to overlap the outer edge of the filmed video by using the first detection model.

The object tracking unit 28 tracks the object detected by the object detection unit 14A. The object tracking unit 28 tracks the object over multiple frames that make up the filmed video and identifies the movement of the object across multiple frames. The object tracking unit 28 identifies, for example, the amount of movement and the direction of movement of the object.

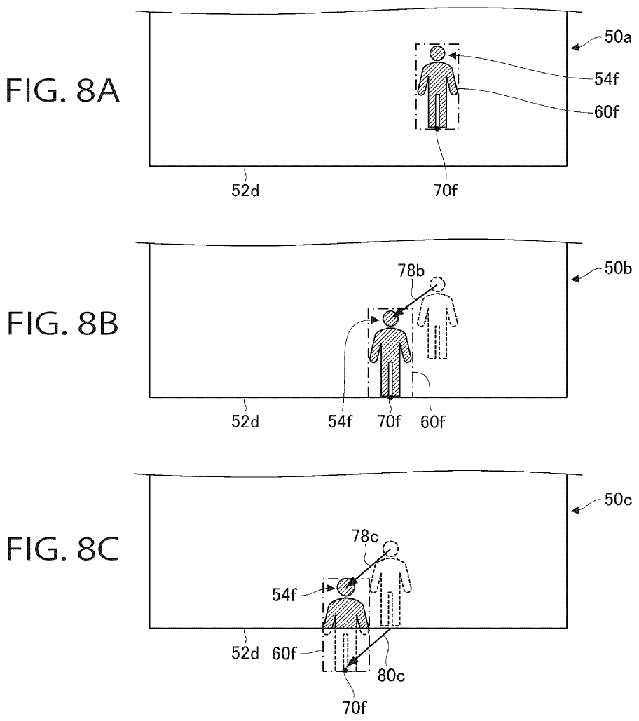

FIGS. 8A-8C schematically show an example of the object tracked over multiple frames that make up the filmed video, showing a state in which an object 54f is moving in a direction toward the lower edge 52d of the filmed video, i.e., a state in which the object 54f is approaching the camera 20.

FIG. 8A shows a filmed video 50a filmed when the object 54f is located at a position distanced in an upward direction from the lower edge 52d. The figure also shows a detection area 60f set when the object 54f is detected in the filmed video 50a. The lower end position of the object 54f is determined to match a lower end position 70f of the detection area 60f. The object tracking unit 28 tracks the object 54f.

FIG. 8B shows a filmed video 50b one or several frames after FIG. 8A. In the filmed video 50b, the lower end position 70f of the detection area 60f set when the object 54f is detected matches the lower edge 52d. In the example of FIG. 8B, the position of the object 54f in FIG. 8A is indicated by a dashed line for ease of explanation, but the object 54f indicated by the dashed line is not filmed in the actual filmed video 50b. The object tracking unit 28 identifies the amount of movement and the direction of movement as indicated by an arrow 78b, based on a difference from the position of the object 54f in the past frame to the position of the object 54f in the current frame. The object tracking unit 28 can identify the movement of the object 54f based on a change in the position of a particular part (e.g., the head) of the object 54f.

Referring to FIG. 8B, the object tracking unit 28 detects that the object 54f is moving in a direction toward the lower edge 52d of the filmed video. Therefore, the object 54f detected in FIG. 8A and the object 54f detected in FIG. 8B are determined to be the same object. Furthermore, the object 54f detected in FIG. 8B is determined to be detected in its entirety because the arrangement of the detection area 60f with respect to the object 54f detected in FIG. 8A and the arrangement of the detection area 60f with respect to the object 54f detected in FIG. 8B are identical. Therefore, it is determined that the lower end position of the object 54f detected in FIG. 8B matches the lower end position 70f of the detection area 60f shown in FIG. 8B.

FIG. 8C shows a filmed video 50c one or several frames after FIG. 8B. In the filmed video 50c, the lower end of the object 54f is located below the lower edge 52d, and the lower part of the object 54f is outside the angle of view of the camera 20. In the example of FIG. 8C, too, the position of the object 54f in FIG. 8B is indicated by a dashed line for ease of explanation, but the object 54f indicated by the dashed line is not filmed in the actual filmed video 50c. The object tracking unit 28 identifies the amount of movement and the direction of movement as indicated by an arrow 78c, based on a difference from the position of the object 54f in the past frame to the position of the object 54f in the current frame.

The lower end estimation unit 30 estimates the lower end position of the object. The lower end estimation unit 30 estimates, when an object located at the lower edge of the filmed video is detected, the lower end position of the object potentially located below the lower edge of the filmed video. Further, the lower end estimation unit 30 estimates the lower end position of the object based on the size of the object above the lower edge of the filmed video.

Referring to FIG. 8C, the object tracking unit 28 detects that the object 54f is moving in a direction toward the lower edge 52d of the filmed video. Referring to FIG. 8C, the recognition score according to the first detection model is low because the entirety of the object 54f is not included in the filmed video 50c. Since it is estimated by the object tracking unit 28 that the object 54f is located at a position that overlaps the lower edge 52d of the filmed video, however, the first detection unit 24A defines the detection area 60f shown in FIG. 8C as the detection area of the object 54f. Therefore, it is determined that the lower end position of the object 54f detected in FIG. 8C matches the lower end position 70f of the detection area 60f shown in FIG. 8C.

The lower end estimation unit 30 may estimate the lower end position 70f at the point of time of FIG. 8C, based on the lower end position 70f at the point of time of FIG. 8B and the movement, indicated by the arrow 78c, of the object 54f tracked from the point of time of FIG. 8B up to the point of time of FIG. 8C. For example, the lower end position 70f at the point of time of FIG. 8C can be estimated by adding the amount of movement (movement vector) indicated by the arrow 78c to the lower end position 70f at the point of time of FIG. 8B, as indicated by an arrow 80c.

Referring to FIG. 8C, the entire image of the object 54f is not included in the filmed video 50 so that the lower end estimation unit 30 may detect the detection area in the filmed video 50c, in which the object 54f is detected, in a size smaller in the vertical direction than the detection area 60f of the object 54f detected in FIG. 8B. In this case, the detection area 60f of the object 54f may be estimated to be positioned to overlap the lower edge 52d of the filmed video, as indicated by the detection area 60f shown in FIG. 8C. Specifically, the lower end estimation unit 30 estimates the lower end position of the object 54f based on the vertical size in which the object 54f shown in FIG. 8C is detected, i.e., the size above the lower edge 52d. For example, the lower end position of the object 54f is estimated by estimating the detection area 60f including the entire image of the object 54f in FIG. 8C from the vertical size of the object 54f in FIG. 8C tracked and detected by the object tracking unit 28, based on the position of the detection area 60f and the size of the detection area 60f of the object 54f detected in FIG. 8A or FIG. 8B.

The distance calculation unit 16A calculates distance information on the object by using the lower end position of the object estimated by the lower end estimation unit 30. The distance calculation unit 16A can calculate the distance information on the object by using the same method as the distance calculation unit 16 according to the first embodiment described above.

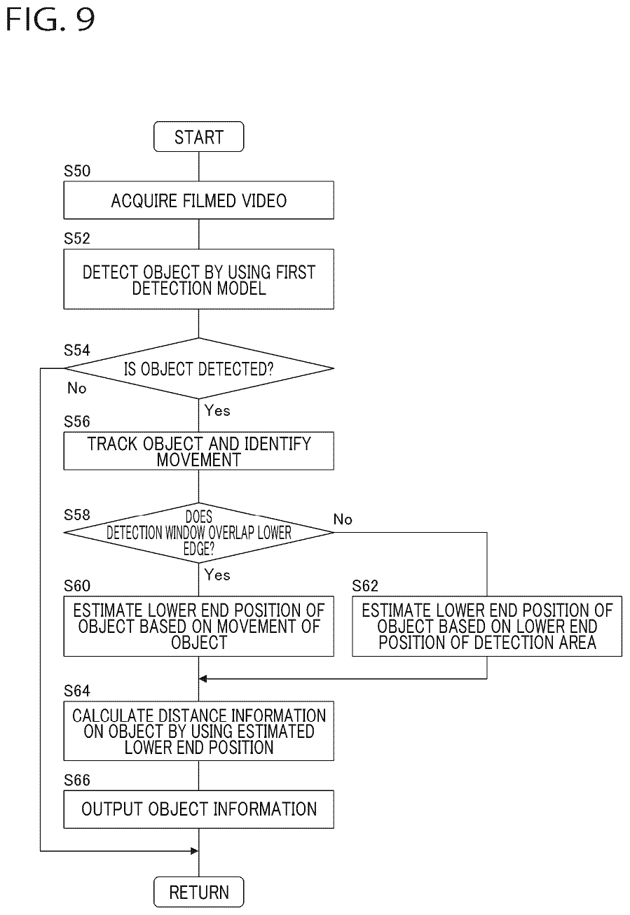

FIG. 9 is a flowchart showing an exemplary flow of the recognition processing method according to the second embodiment. The video acquisition unit 12 acquires the filmed video filmed by the camera 20 (step S50). The object detection unit 14A starts scanning the filmed video by using a detection window and starts detecting the object by using the first detection model (step S52).

The object detection unit 14A then determines whether the object is detected from the filmed video filmed by the camera 20 (step S54). If it is determined in step S54 that the object is detected (Yes in step S54), the object tracking unit 28 tracks the object over multiple frames and identifies the movement of the object (step S56). The lower end estimation unit 30 estimates the lower end position of the object based on the movement of the object (step S60) when the detection area in which the tracked object is detected is positioned to overlap the lower edge of the filmed video (Yes in step S58). The lower end estimation unit 30 estimates the lower end position of the object based on the lower end position of the detection area (step S62) when the detection area in which the tracked object is detected is not positioned to overlap the lower edge of the filmed video (No in step S58)

After steps S60 and S62, the distance calculation unit 16A calculates distance information on the object by using the estimated lower end position of the object (step S64). The output control unit 18 outputs object information on the detected object (step S66). When it is not determined in step S54 that the object is detected (No in step S54), the processes S56-S66 can be skipped.

According to the embodiment, the lower end position of the object can be estimated even if the lower end position of the object is not included in the angle of view of the filmed video because of the object's position at the lower edge of the filmed video. As a result, the distance to the object located near the camera 20 can be calculated more properly.

### Third Embodiment

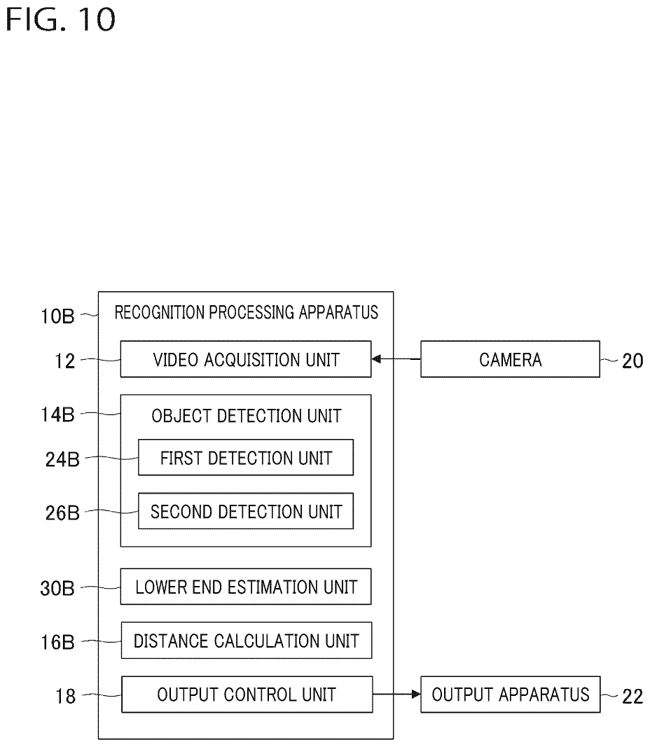

FIG. 10 is a block diagram schematically showing a functional configuration of a recognition processing apparatus 10B according to the third embodiment. The recognition processing apparatus 10B according to the third embodiment differs from the above embodiments in that it switches from the first detection model to the second detection model to detect the object when the object is located at a position that overlaps the lower edge of the filmed video. The following description of the third embodiment highlights the difference from the first embodiment and the second embodiment. A description of common features is omitted as appropriate.

The recognition processing apparatus 10B is equipped with a video acquisition unit 12, an object detection unit 14B, a lower end estimation unit 30B, a distance calculation unit 16B, and an output control unit 18. The video acquisition unit 12 and the output control unit 18 may be configured in a manner similar to the first embodiment or the second embodiment. The object detection unit 14B is equipped with a first detection unit 24B and a second detection unit 26B.

The first detection unit 24B may be configured in the same manner as the first detection unit 24A according to the second embodiment. The first detection unit 24B detects an object by using the first detection model trained on the entire image of the object by machine learning. The first detection unit 24B detects an object included in the filmed video by using the first detection model. The first detection unit 24B detects an object located near the center of the filmed video by using the first detection model and also detects an object located at the outer edge of the filmed video by using the first detection model. The first detection unit 24B detects an object located at the lower edge of the filmed video by using the first detection model.

When the first detection unit 24B detects an object included in a position that overlaps the lower edge of the filmed video, the second detection unit 26B detects the object included in the position that overlaps the lower edge of the filmed video by using the second detection model trained on an upper partial image of the object by machine learning. The second detection unit 26B uses the second detection model to detect the object, for which a part toward the top of the object is included in the filmed video and a part toward the bottom of the object is outside the angle of view and is not included in the filmed video because the object is included in a position that overlaps the lower edge of the filmed video.

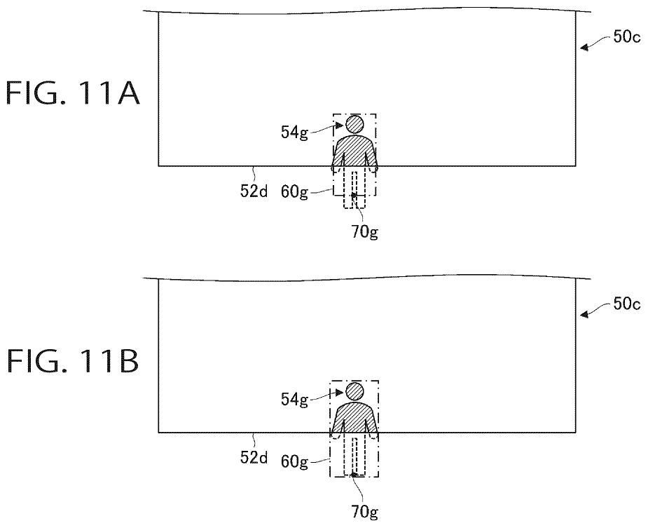

FIGS. 11A, 11B schematically show an exemplary method of detecting an object included in a position that overlaps the lower edge of the filmed video. FIGS. 11A, 11B show a filmed video 50c like the one in FIG. 8C according to the second embodiment described above. FIG. 11A schematically shows a state in which an object 54g is detected by the first detection unit 24B. The first detection unit 24B scans a detection window in the filmed video 50c and detects the object by using the first detection model. FIG. 11A shows a state in which the filmed video 50c does not include the entirety of the object 54g, and so a lower end position 70g of a detection area 60g set when the object 54g is detected is different from the lower end position inherent to the object 54g. FIG. 11B schematically shows a state in which the object 54g is detected by the second detection unit 26B. The second detection unit 26B scans a detection window in an area of the filmed video 50 which includes the detection area in which the object is detected by the first detection model and a nearby range. The second detection unit 26B detects the object by using the second detection model. FIG. 11B shows a state in which the object 54g is included in a range that overlaps the lower edge of the filmed video 50c, and the lower end position 70g of the detection area 60g set when the object 54g is detected by the second detection model is estimated.

The lower end estimation unit 30B estimates the lower end position of the object. When an object included in a range that overlaps the lower edge of the filmed video is detected by the first detection unit 24B, the lower end estimation unit 30B identifies the lower end position of the detection area detected by the second detection unit 26B to be the lower end position of the detected object. In the case as shown in FIG. 11B, for example, the lower end estimation unit 30B identifies the lower end position 70g of the detection area 60g of the object 54g detected by the second detection unit 26B to be the lower end position of the object 54g.

The distance calculation unit 16B calculates the distance information on the object by using the lower end position of the object estimated by the lower end estimation unit 30B. The distance calculation unit 16B may calculate the distance information on the object by using the same method as the distance calculation unit 16 according to the first embodiment described above.

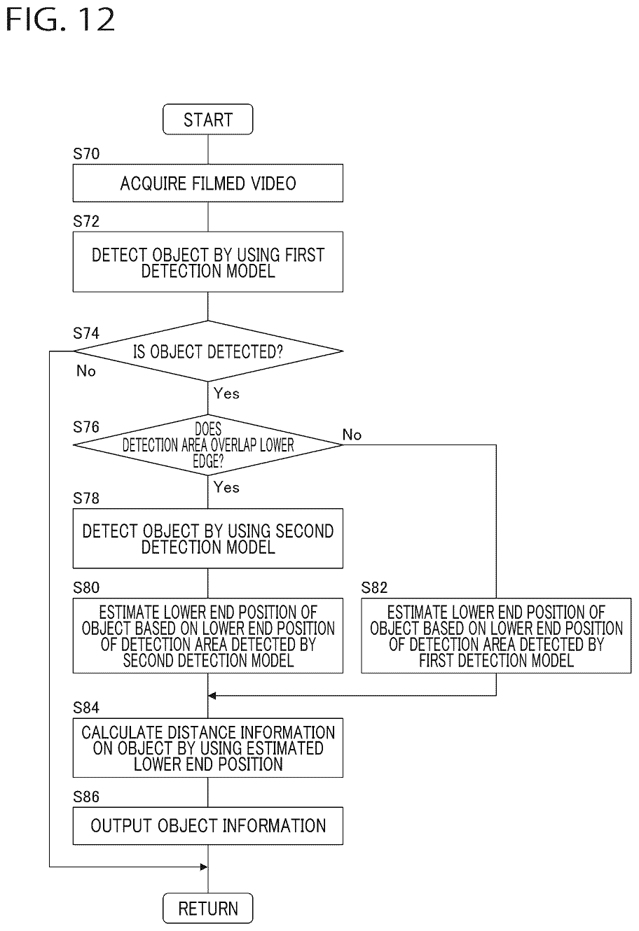

FIG. 12 is a flowchart showing an exemplary flow of the recognition processing method according to the third embodiment. The video acquisition unit 12 acquires the filmed video filmed by the camera 20 (step S70). The object detection unit 14B starts scanning the filmed video by using a detection window and starts detecting the object by using the first detection model (step S72).

The object detection unit 14B then determines whether an object is detected from the filmed video filmed by the camera 20 (step S74). When it is determined in step S74 that an object is detected (Yes in step S54), the object detection unit 14B determines whether the detection area of the object detected in step S74 is included in a range that overlaps the lower edge of the filmed video (step S76). When it is determined in step S76 that the detection area of the detected object is included in a range that overlaps the lower edge of the filmed video (Yes in step S76), the object detection unit 14B detects the object by using the second detection model (step S78). Further, the lower end estimation unit 30 estimates the lower end position of the object based on the lower end position of the detection area of the object detected in step S78 by the second detection model (step S80)

When it is not determined in step S76 that the detection area of the detected object is included in a range that overlaps the lower edge of the filmed video (No in step S76), the lower end estimation unit 30B estimates the lower end position of the object based on the lower end position of the detection area of the object detected by the first detection model (step S82).

After steps S80 and S82, the distance calculation unit 16B calculates distance information on the object by using the estimated lower end position of the object (step S84). The output control unit 18 outputs object information on the detected object (step S86). When it is not determined in step S74 that the object is detected (No in step S74), the processes S76-S76 can be skipped.

According to the embodiment, the lower end position of the object can be estimated by detecting the object by using the second detection model when the lower end position of the object is not included in the angle of view of the filmed video because of the object's position at the lower edge of the filmed video. As a result, the distance information on the object located near the camera 20 can be calculated more properly.

The present disclosure has been explained with reference to the embodiments described above, but the present disclosure is not limited to the embodiments described above, and appropriate combinations or replacements of the features presented in the embodiments are also encompassed by the present disclosure.

Some embodiments of the present disclosure will now be described.

The first embodiment of the present disclosure relates to a recognition processing apparatus including: a video acquisition unit that acquires a filmed video; an object detection unit that detects an object located away from an outer edge of the filmed video by using a first detection model trained on an entire image of the object by machine learning and detects an object located at the outer edge of the filmed video by using a second detection model trained on a partial image of the object by machine learning.

The second embodiment of the present disclosure relates to a recognition processing method including: acquiring a filmed video; detecting an object located away from an outer edge of the filmed video by using a first detection model trained on an entire image of the object by machine learning and detecting an object located at the outer edge of the filmed video by using a second detection model trained on a partial image of the object by machine learning.

The third embodiment of the present disclosure relates to a program or a non-transitory recording medium storing the program, the program including processor-implemented modules including: a module that acquires a filmed video; a module that detects an object located away from an outer edge of the filmed video by using a first detection model trained on an entire image of the object by machine learning and detects an object located at the outer edge of the filmed video by using a second detection model trained on a partial image of the object by machine learning.

The fourth embodiment of the present disclosure relates to a recognition processing apparatus including: a video acquisition unit that acquires a filmed video; an object detection unit that detects an object included in the filmed video by using a detection model trained on an image of the object by machine learning; a lower end estimation unit that estimates, when the object included in a range that overlaps a lower edge of the filmed video is detected by the object detection unit, a lower end position of the object potentially located below the lower edge of the filmed video; and a distance calculation unit that calculates distance information on the object by using the lower end position estimated by the lower end estimation unit.

The fifth embodiment of the present disclosure relates to a recognition processing method including: acquiring a filmed video; detecting an object included in the filmed video by using a detection model trained on an image of the object by machine learning; estimating, when the object included in a range that overlaps a lower edge of the filmed video is detected, a lower end position of the object potentially located below the lower edge of the filmed video; and calculating distance information on the object by using the lower end position estimated.

The sixth embodiment of the present disclosure relates to a non-transitory recording medium storing a program including processor-executed modules including: a module that acquires a filmed video; a module that detects an object included in the filmed video by using a detection model trained on an image of the object by machine learning; a module that estimates, when the object included in a range that overlaps a lower edge of the filmed video is detected, a lower end position of the object potentially located below the lower edge of the filmed video; and a module that calculates distance information on the object by using the lower end position estimated.

According to the embodiments of the present disclosure, a technology for detecting an object more properly in an image recognition process can be provided.

What is claimed is:

1. A recognition processing apparatus comprising:
a video acquisition unit that acquires a filmed video;
an object detection unit that detects an object included in the filmed video by using a detection model trained on an image of the object by machine learning;
a lower end estimation unit that estimates, when the object included in a range that overlaps a lower edge of the filmed video is detected by the object detection unit, a lower end position of the object potentially located below the lower edge of the filmed video; and
a distance calculation unit that calculates distance information on the object by using the lower end position estimated by the lower end estimation unit.

2. The recognition processing apparatus according to claim 1, further comprising:
an object tracking unit that tracks the object detected by the object detection unit,
wherein the lower end estimation unit estimates the lower end position of the object potentially located below the lower edge of the filmed video, based on a movement of the object that moves the lower end position of the object tracked by the object tracking unit to an area below the lower edge of the filmed video.

3. The recognition processing apparatus according to claim 2,
wherein the lower end estimation unit estimates the lower end position of the object based on a size of the object detected by the object detection unit above the lower edge of the filmed video.

4. The recognition processing apparatus according to claim 1,
wherein the object detection unit detects the object included in the filmed video by using a first detection model trained on an entire image of the object by machine learning,
wherein, when the object detection unit detects the object included in a range that overlaps the lower edge of the filmed video by using the first detection model, the object detection unit detects the object included in a range that overlaps the lower edge of the filmed video by using a second detection model trained on an upper partial image of the object by machine learning, and
wherein the lower end estimation unit estimates the lower end position of the object by using a lower end position of a detection area of the object detected by using the second detection model.

5. The recognition processing apparatus according to claim 4,
wherein, when the object detection unit detects, as the object included in the range that overlaps the lower edge of the filmed video, the object for which a part toward a top of the object is included in the filmed video and a part toward a bottom of the object is outside an angle of view and is not included in the filmed video by using the first detection model, the object detection unit detects the object included in the range that overlaps the lower edge of the filmed video by using the second detection model.

6. A recognition processing method comprising, for execution by a recognition processing apparatus:
acquiring a filmed video;
detecting an object included in the filmed video by using a detection model trained on an image of the object by machine learning;
estimating, when the object included in a range that overlaps a lower edge of the filmed video is detected, a lower end position of the object potentially located below the lower edge of the filmed video; and
calculating distance information on the object by using the lower end position estimated.

7. A non-transitory recording medium storing a program comprising processor-executed modules including:
a module that acquires a filmed video;
a module that detects an object included in the filmed video by using a detection model trained on an image of the object by machine learning;
a module that estimates, when the object included in a range that overlaps a lower edge of the filmed video is detected, a lower end position of the object potentially located below the lower edge of the filmed video; and
a module that calculates distance information on the object by using the lower end position estimated.
